(19) United States
(12) Patent Application Publication
(10) Pub. No.: US 2012/0120123 A1
(43) Pub. Date: May 17, 2012

(54) BACKLIGHT APPARATUS, IMAGE DISPLAY SYSTEM AND LIGHTING APPARATUS

(75) Inventor: Takeshi ADACHI, Saitama (JP)

(73) Assignees: ATRC CORPORATION; MITSUMI ELECTRIC CO., LTD.

(21) Appl. No.: 13/292,439

(22) Filed: Nov. 9, 2011

(30) Foreign Application Priority Data
Nov. 11, 2010 (JP) 2010-252741

(51) Int. Cl. G09G 5/10; H05B 37/02

(52) U.S. Cl. 345/690; 315/192

(57) ABSTRACT

A backlight apparatus for illuminating a display unit, includes: light-emitting elements that are arranged at predetermined intervals; and a driving control unit configured to supply currents to the light-emitting elements so as to control driving of the light-emitting elements, wherein the light-emitting elements include a pair of a first light emitting-element and a second light-emitting element that are connected to the driving control unit and that are connected in parallel to each other, in which the first light-emitting element is connected in a direction opposite to a direction in which the second light-emitting element is connected.

### CROSS-REFERENCE TO RELATED APPLICATION

The present application is based upon and claims the benefit of priority of Japanese Patent Application No. 2010-252741, filed on Nov. 11, 2010, the entire contents of which are incorporated herein by reference.

### BACKGROUND OF THE INVENTION

1. Field of the Invention

The present invention relates to a backlight apparatus, an image display system and a lighting apparatus including the backlight apparatus. More specifically, the present invention relates to a backlight apparatus, an image display system and a lighting apparatus including the backlight apparatus for realizing cost reduction, and improving driving efficiency and driving speed.

2. Description of the Related Art

Backlights using light-emitting elements such as LED (Light Emitting Diode) are attracting attention as backlights for illuminating an optical modulation device, from the backside, such as a liquid crystal panel that is commonly used for a display apparatus for displaying an image and a video and the like. The liquid crystal panel (LCD panel) is commonly used as a display part of a liquid crystal display apparatus.

There are several types of LED backlights. For example, in one type of LED backlights, white LEDs are arranged in order to emit white illuminating light. In another type of LED backlights, LEDs of three colors of R (red), G (green) and B (blue) are arranged so that the three colors are mixed to emit white light. Also, as to the white LED, there are several types. In one type of the white LED, fluorescent material is combined with a short-wavelength LED to obtain white light. In another type, fluorescent material is combined with a blue LED to obtain white light. Also, there is a type in which yellow fluorescent material is combined with a blue LED to obtain white light.

Plural LEDs are necessary for realizing a lighting apparatus and backlight of an LCD panel in order to emit bright and stable light. Further, it is necessary to arrange plural LEDs at predetermined positions or at predetermined intervals and to drive each LED at proper timing.

Japanese Laid-Open Patent Applications No. 2006-203182 and 2008-142143 disclose examples of conventional apparatuses using LEDs. In the technical field, it is required to reduce production cost, and to improve efficiency and speed for driving light-emitting elements such as LEDs.

### SUMMARY OF THE INVENTION

An object of the present invention is to provide a technique for reducing production cost, and to improve driving efficiency and driving speed.

According to an embodiment of the present invention, there is provided a backlight apparatus for illuminating a display unit, including:

light-emitting elements that are arranged at predetermined intervals; and

a driving control unit configured to supply currents to the light-emitting elements so as to control driving of the light-emitting elements,

wherein the light-emitting elements include a pair of a first light emitting-element and a second light-emitting element that are connected to the driving control unit and that are connected in parallel to each other, in which the first light-emitting element is connected in a direction opposite to a direction in which the second light-emitting element is connected.

According to another embodiment of the present invention, there is provided an image display system including:

a backlight apparatus;

a display unit to be illuminated by the backlight apparatus,

the backlight apparatus comprising:

light-emitting elements that are arranged at predetermined intervals; and

a driving control unit configured to supply currents to the light-emitting elements so as to control driving of the light-emitting elements,

wherein the light-emitting elements include a pair of a first light emitting-element and a second light-emitting element that are connected to the driving control unit and that are connected in parallel to each other, in which the first light-emitting element is connected in a direction opposite to a direction in which the second light-emitting element is connected.

According to still another embodiment of the present invention, there is provided a lighting apparatus including:

light-emitting elements that are arranged at predetermined intervals; and

a driving control unit configured to supply currents to the light-emitting elements so as to control driving of the light-emitting elements,

wherein the light-emitting elements include a pair of a first light emitting-element and a second light-emitting element that are connected to the driving control unit and that are connected in parallel to each other, in which the first light-emitting element is connected in a direction opposite to a direction in which the second light-emitting element is connected.

According to an embodiment of the present invention, it becomes possible to reduce production cost, and to improve driving efficiency and driving speed.

Other objects and further features of the present invention will be apparent from the following detailed description when read in conjunction with the accompanying drawings.

### BRIEF DESCRIPTION OF THE DRAWINGS

FIG. 1A is a schematic diagram showing an example of an LED driving circuit (lighting-element driving circuit);

FIG. 1B is a diagram showing currents supplied to LEDs;

FIG. 2A is a schematic diagram showing an example of an LED driving circuit of an embodiment of the present invention;

FIG. 2B is a diagram showing currents supplied to LEDs;

FIG. 3 is a diagram showing an example of an internal circuit of the driver IC according to an embodiment of the present invention;

FIG. 4 is a diagram showing examples of PWM output waveforms in the embodiment shown in FIG. 3;

FIG. 5 is a diagram showing an example of an LED driving circuit using an even number of LEDs equal to or greater than 4.

FIGS. 6A-6C are schematic diagrams showing examples of configurations of backlight apparatuses;

FIGS. 7A-7E are diagrams for explaining arrangement examples of LED backlights;

FIGS. 8A and 8B are diagrams showing examples of block configurations according to an embodiment of the present invention;

FIG. 9 is a diagram showing an example of a block configuration of the backlight control IC (PWM) 54 according to an embodiment of the present invention;

FIG. 10 is a diagram showing an example of a functional configuration of an image display system using the backlight apparatus according to an embodiment of the present invention; and

FIGS. 11A and 11B are diagrams for explaining other application examples of the backlight apparatus according to an embodiment of the present invention.

### DESCRIPTION OF THE PREFERRED EMBODIMENTS

Prior to describing embodiments of the present invention, problems will be described in more detail with reference to figures for convenience of understanding.

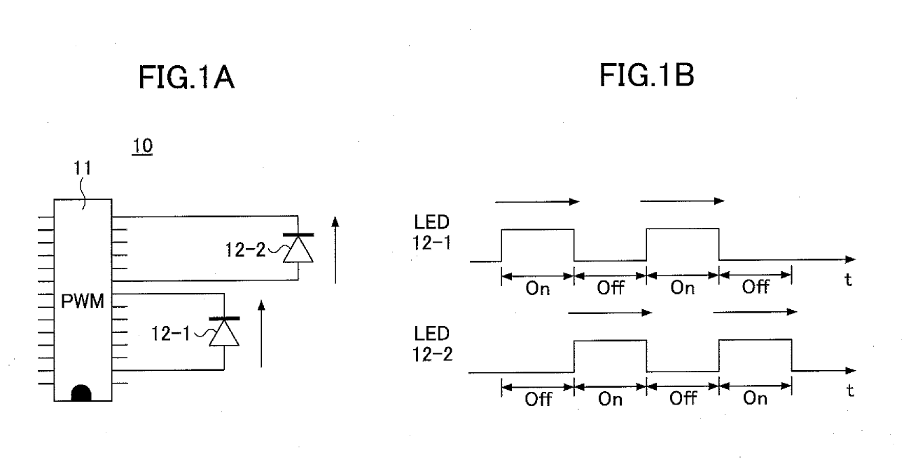

FIG. 1A is a schematic diagram showing an example of an LED driving circuit. The LED driving circuit 10 shown in FIG. 1A includes a driver IC (PWM (Pulse Width Modulation)) 11 that is an IC driving circuit, and LEDs 12-1 and 12-2 that are light-emitting elements.

The driver IC 11 controls current output time (pulse width of driving signal) for each of connected LEDs so as to drive the LEDs at respective timing. Generally, there are an alternating current scheme and a direct current scheme for driving an LED. In both of the schemes, there are a period in which the LED is turned on (lighting) and a period in which the LED is turned off (not-lighting). In the example shown in FIG. 1A, two LEDs 12-1 and 12-2 are connected serially with respect to the driver IC 11. Therefore, as shown in FIG. 1B, ON/OFF driving control is performed alternately for the LEDs 12-1 and 12-2.

As shown in FIGS. 1A and 1B, in the case where plural LEDs are connected serially, there are a period of driving and a period of not-driving for one LED. Also, since each LED is connected to connected terminals (pins) of the driver IC, it is necessary that the driver IC has terminals (pins) corresponding to the number of LEDs to be connected. Therefore, it is difficult to improve use efficiency of the driver IC. The backlight apparatus described below as an embodiment can solve the above-mentioned problem.

Preferred embodiments of the present invention are described below with reference to the accompanying drawings. In the present embodiments, the meaning of “image signal” includes both of a signal of a moving picture (moving image) and a signal of a still image.

<Outline of Embodiment>

According to an embodiment of the present invention, a backlight apparatus (50) for illuminating a display unit (51) is provided. The backlight apparatus (50) includes:

light-emitting elements (12) that are arranged at predetermined intervals; and

a driving control unit (21) configured to supply currents to the light-emitting elements (12) so as to control driving of the light-emitting elements (12),

wherein the light-emitting elements (12) include a pair of a first light emitting-element and a second light-emitting element that are connected to the driving control unit and that are connected in parallel to each other, in which the first light-emitting element is connected in a direction opposite to a direction in which the second light-emitting element is connected.

The driving control unit (21) may include a differential circuit configured to control the currents supplied to the light-emitting elements.

The backlight apparatus (50) may further include a current resistance unit (RL1-RL4) configured to adjust supplied currents for each of the light-emitting elements.

The backlight apparatus (50) may further include a backlight driving control unit (54) configured to generate a driving condition for the driving control unit (21, 53) and to output a driving control signal to the driving control unit (21, 53).

Also, according to an embodiment of the present invention, an image display system (90) including the backlight apparatus (50) and a display unit to be illuminated by the backlight apparatus can be provided.

The image display system (90) may further include:

a block-unit control unit (93) configured to divide each frame, included in an input image signal, into blocks corresponding to block information that is set beforehand; and

a brightness correction unit (94) configured to perform brightness correction for each of the blocks obtained by the block-unit control unit,

wherein the backlight apparatus (50) performs drive control on plural light-emitting elements assigned for each block based on correction information obtained by the brightness correction unit.

In addition, according to an embodiment of the present invention, a lighting apparatus (100) is provided. The lighting apparatus (100) includes:

light-emitting elements (102) that are arranged at predetermined intervals; and

a driving control unit (103) configured to supply currents to the light-emitting elements so as to control driving of the light-emitting elements,

wherein the light-emitting elements (102) include a pair of a first light emitting-element and a second light-emitting element that are connected to the driving control unit and that are connected in parallel to each other, in which the first light-emitting element is connected in a direction opposite to a direction in which the second light-emitting element is connected.

The above reference symbols are merely examples, and the present invention is not limited by the reference symbols.

According to an embodiment of the present invention, light-emitting elements that are used for lighting and backlights of an LCD panel and the like are connected in parallel and opposite to each other by using BTL (Bridged Transless) connection, so as to turn on the light-emitting elements at high speed. The light-emitting elements are driven based on differential operation instead of element-by-element driving. Although LEDs are used as an example of the light-emitting elements in the present embodiment, the present invention is not limited to using LEDs.

As mentioned before, in general, there are an alternating current scheme and a direct current scheme for driving an LED. In both of the schemes, there are a period in which the LED is turned on (lighting) and a period in which the LED is turned off (not-lighting). In the present embodiment, driving of LEDs is controlled based on a differential connection so that the length of the driving period can be doubled.

By using the scheme of the present embodiment, the number of pins of the driver IC can be decreased by one half for connecting the same number of LEDs. On the other hand, twice as many as LEDs can be connected to one driver IC. In addiction, according to the present embodiment, driving efficiency doubles, and driving speed increases. Therefore, a cost of a backlight driving circuit can be easily reduced.

<LED Driving Circuit (Light-Emitting Element Driving Circuit)>

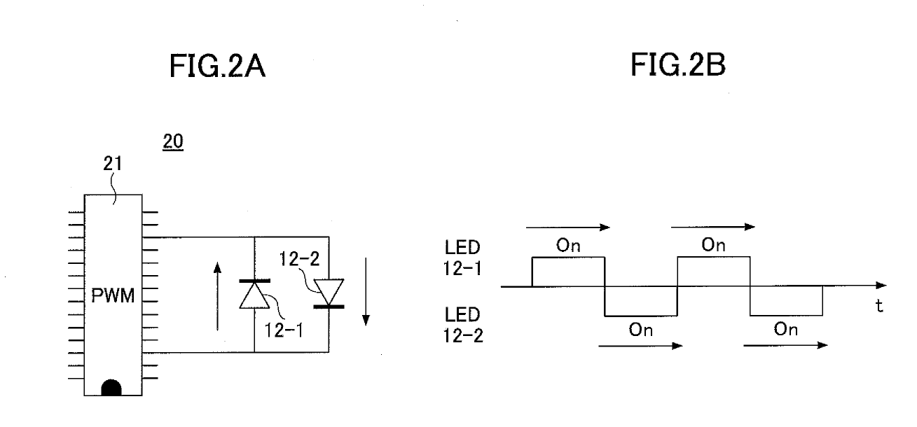

First, an outline example of an LED driving circuit of the present embodiment is described with reference to FIGS. 2A and 2B. FIGS. 2A and 2B are schematic diagrams showing an example of the LED driving circuit in the present embodiment.

The LED driving circuit 20 shown in FIG. 2A includes a driver IC 21 and LEDs 12-1 and 12-2. The driver IC 21 is a driving control unit for controlling current output time (pulse width of driving signal) for each of connected LEDs by using a PWM method so as to drive each LED at respective proper timing. That is, the driver IC 21 includes a PWM oscillation unit, so that the driver IC 21 can perform driving control for each of the LEDs 12-1 and 12-2 at predetermined timing by pulse width control.

In the example shown in FIG. 2A, the LEDs 12-1 and 12-2 are connected in parallel to each other, and are connected to the driver IC 21 in which the LEDs 12-1 and 12-2 are oppositely-oriented with each other. By connecting in parallel and opposite to each other the LEDs 12-1 and 12-2 using BTL connection and driving them based on differential operation instead of element-by-element operation, the LEDs can be driven at high speed.

In the present embodiment, it is possible to provide more LEDs and connect in parallel the LEDs as mentioned above. Also in such a configuration in which more LEDs are connected, by controlling the connected LEDs based on differential operation as described later, use efficiency of the driver IC can be improved and the driving speed can be increased. Also, according to the present embodiment, since one or more LED pairs are connected in parallel, the number of pins to be used can be decreased compared to a conventional serial type device. Therefore, cost can be reduced.

Colors of the connected-in-parallel LEDs as a pair may be the same or may be different.

<Internal Circuit of the Driver IC in the LED Driving Circuit 20>

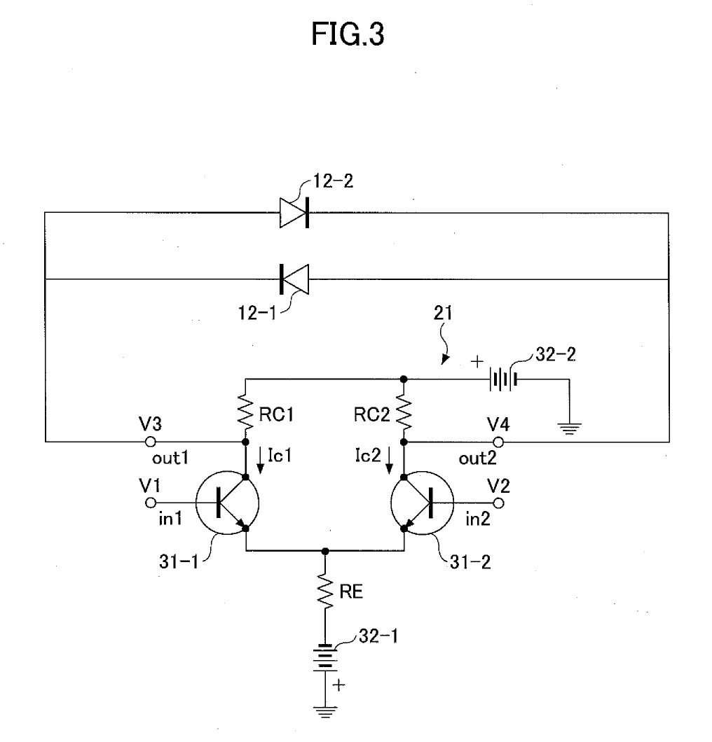

Next, the internal circuit of the driver IC in the above-mentioned LED driving circuit 20 is described with reference to figures. FIG. 3 shows an example of the internal circuit of the driver IC according to the present embodiment. As shown in FIG. 3, the driver IC 21 is provided with a differential circuit. More particularly, the driver IC 21 includes two transistors 31-1 and 31-2, voltage units 32-1 and 32-2, and resistances RC1, RC2 and RE. NPN type transistors are used as the transistors 31-1 and 31-2 in this example. But, the transistors are not limited to the NPN type in embodiments of the present invention. Instead of the NPN type transistors, PNP type transistors, FETs and the like may be used.

In the circuit configuration shown in FIG. 3, in each of the transistors 31-1 and 31-2, an amount of current that flows between the emitter and the collector is controlled by an amount of current flowing into the base. That is, as to the transistor 31-1, an amount of current obtained by the resistances RC1 and RE between the voltage units 32-1 and 32-2 is controlled by an amount of current input from a terminal V1. Also, as to the transistor 31-2, an amount of current obtained by the resistances RC2 and RE between the voltage units 32-1 and 32-2 is controlled by an amount of current input from a terminal V2.

According to the circuit configuration shown in FIG. 3, one of the two transistors 31-1 and 31-2 operates as an amplifier circuit of a grounded emitter circuit type, and at the same time, another one of the two transistors 31-1 and 31-2 operates as an emitter follower. Thus, one input is supplied to another emitter. Therefore, by supplying plus and minus (or minus and plus) voltages to the terminals V1 and V2 respectively, a signal can be supplied by the above-mentioned differential circuit.

Since each of the transistors 31-1 and 31-2 amplifies a current between the base and the emitter, a current flowing through the collector is in proportion to a difference between the two inputs. However, since this circuit has a complete symmetrical shape, if one of the transistors is regarded as the amplifier circuit, another one becomes the emitter follower, and vice versa.

Therefore, the LED driving circuit 20 can supply PWM waves in which plus and minus are reversed as shown in FIG. 2B, for example, to the LEDs 12-1 and 12-2 respectively. Also, in the present embodiment, an amount of current for the LED 12-1 can be adjusted by the resistance RC1. Also, an amount of current for the LED 12-2 can be adjusted by the resistance RC2. Therefore, according to the present embodiment, it is possible to adjust a supplied current amount for each LED according to LED color and the like, so that an amount of emitted light (brightness level) can be adjusted.

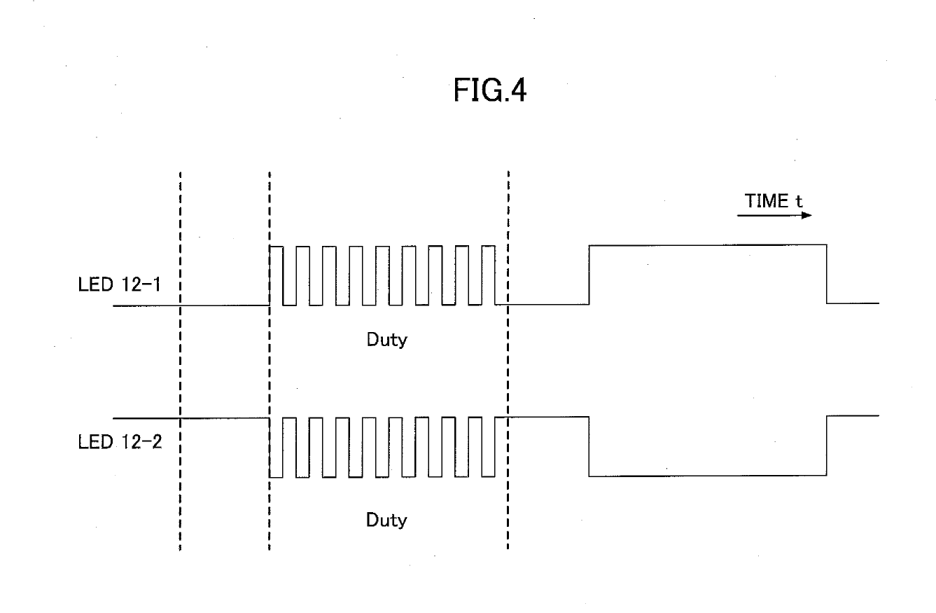

FIG. 4 is a diagram showing examples of PWM output waveforms in the embodiment shown in FIG. 3. FIG. 4 shows examples of PWM output waveforms supplied from the driver IC 21 to the LEDs 12-1 and 12-2 shown in FIG. 3.

As show in FIG. 4, the LEDs 12-1 and 12-2 receive signals of currents in which minus and plus are reversed with respect to time t. Therefore, in the LEDs 12-1 and 12-2 that are connected in parallel in a reverse direction to each other, lighting can be performed alternately. The duty time of the waveform (the time of “High” in a pulse cycle) is the same between the LEDs 12-1 and 12-2.

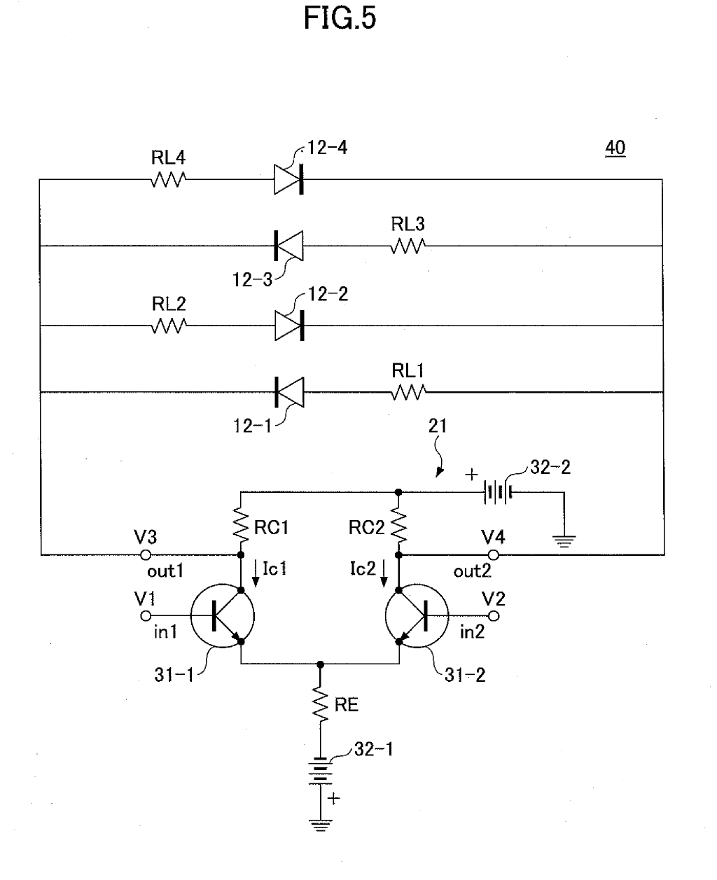

The present invention is not limited to the above-mentioned internal configuration of the driver IC 21 that is applied to lighting of two LEDs. For example, in the case when there are an even number of LEDs equal to or greater than 4 for the driver IC 21, the above-mentioned processing can be performed for each pair of LEDs. An example of this case is described with reference to FIG. 5. FIG. 5 is a diagram showing an example of an LED driving circuit using an even number of LEDs equal to or greater than 4.

Compared to the configuration shown in FIG. 3, in the LED driving circuit 40 shown in FIG. 5, LEDs 12-3 and 12-4 are connected in parallel in addition to the LEDs 12-1 and 12-2. In the example of FIG. 5, LEDs 12-1 and 12-2 form a pair, and LEDs 12-3 and 12-4 form another pair.

Also, the LED 12-3 is connected to the driver IC 21 in the same direction as the direction in which the LED 12-1 is connected, and the LED 12-4 is connected to the driver IC 21 in the same direction as the direction in which the LED 12-2 is connected. In the example of FIG. 5, each of the LEDs 12-1 and 12-3 is connected to the driver IC in a reverse direction with respect to the direction in which each of the LEDs 12-2 and 12-4 is connected to the driver IC.

In this case, the above-mentioned waveform signals of currents in which plus and minus are reversed are supplied to a set of plural LEDs (a first LED group) connected in the same direction and to a set of plural LEDs (a second LED group) connected in the reverse direction respectively, so that the LED groups can be turned ON/OFF alternately. Thus, as a result, continuous lighting can be performed efficiently.

In the example shown in FIG. 5, a current resistance unit including resistances RL1-RL4 is provided for the LEDs 12-1-12-4. These resistances RL1-RL4 are used for adjusting current amounts supplied to the LEDs 12-1-12-4 from the driver IC 21 respectively. Therefore, by using the resistances RL1-RL4, brightness level and the like for each of the LEDs 12-1-12-4 can be controlled according to the types and usage of the LEDs 12-1-12-4.

According to the above-mentioned circuit configuration, oppositely-connected LEDs can be lighted-up at high speed. Also, driving efficiency of the driver IC can be improved, and driving speed can be improved.

<Example of LED Driving Circuit used for Backlight Apparatus>

The above-mentioned LED driving circuit can be used in a backlight apparatus for a liquid crystal panel, for example. In the following, a concrete example of a backlight apparatus to which the LED driving circuit is applied is described with reference to figures.

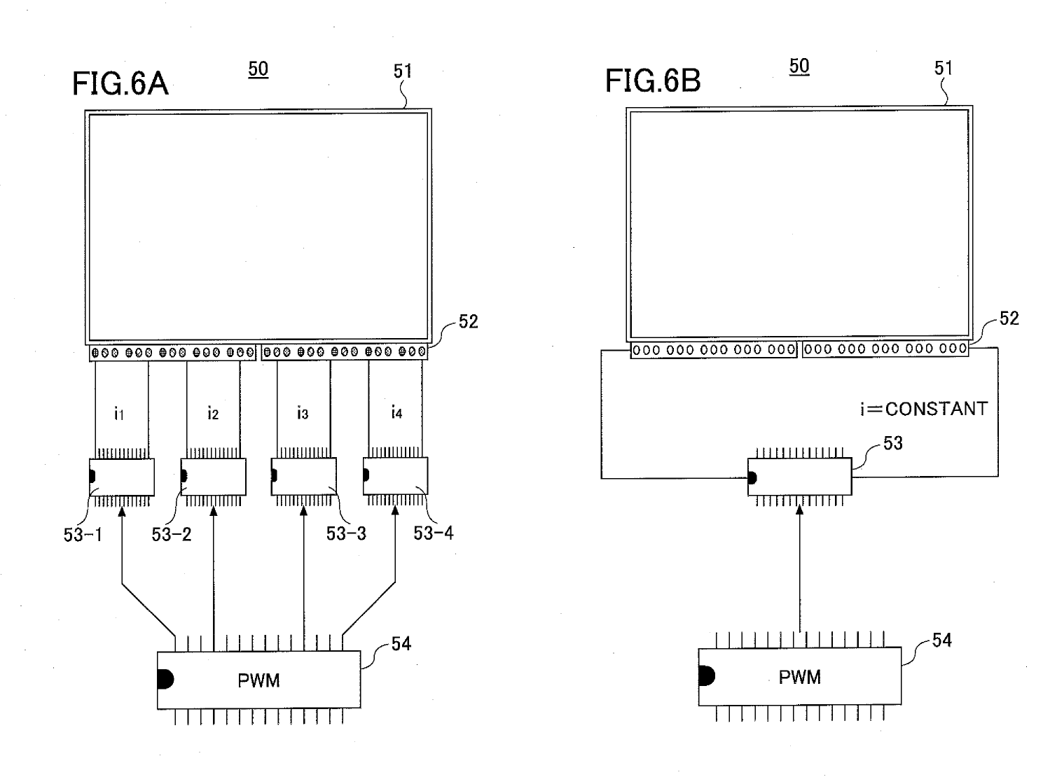

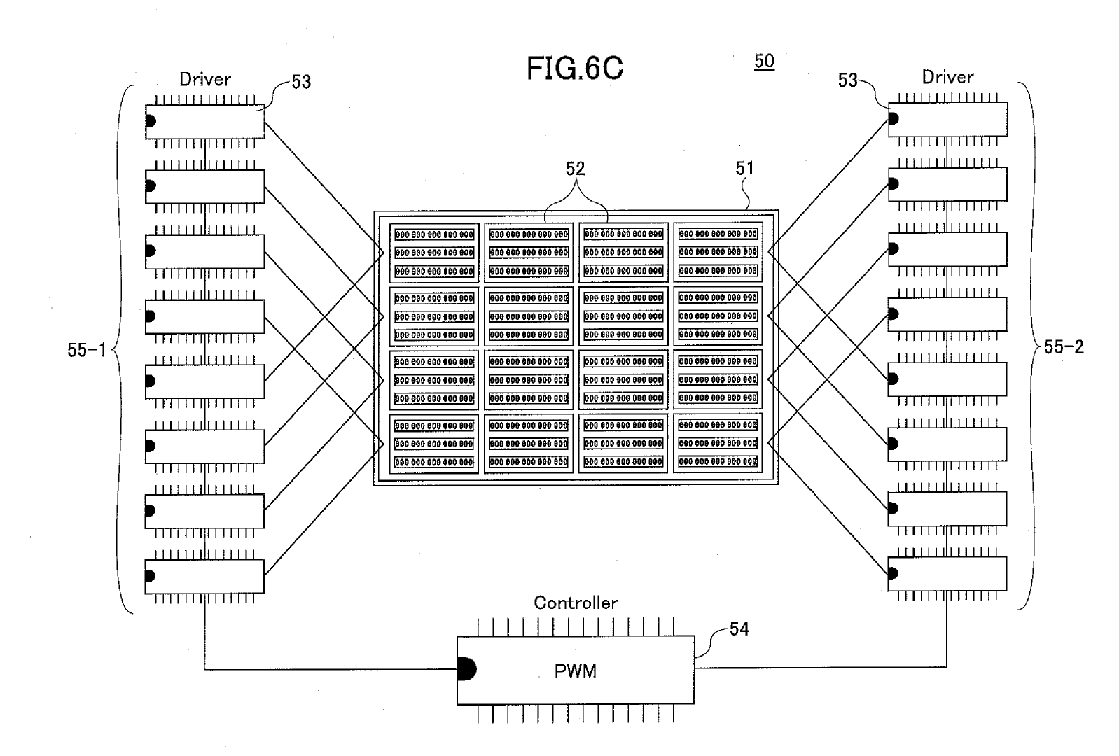

FIGS. 6A-6C are schematic diagrams showing examples of configurations of backlight apparatuses. FIG. 6A shows a configuration example using a low-voltage driver of an edge RGB type in which a backlight unit is provided in an edge part of a display unit such as a liquid crystal panel. FIG. 6B shows a configuration example using a high-voltage driver of an edge W (white) type in which a backlight unit is provided in an edge part of the display unit. FIG. 6C shows a configuration example using plural drivers of a top RGB type in which the backlight unit is provided in the backside of the display unit. As to LED backlight in embodiments of the present invention, the type is not limited to the RGB type and the white type, and other types can be used.

As shown in FIGS. 6A-6C, each backlight apparatus 50 is provided with the display unit 51 such as an LCD (Liquid Crystal Display) panel, an element block 52 in which a plurality of light-emitting elements such as LEDs are arranged at predetermined intervals, a driver IC 53 that is a driver device, and a backlight control IC (PWM) 54 as a backlight driving control unit that is a driver for controlling backlights for the display unit 51.

Each LED in the element block 52 is connected to the driver IC 53 by the connection method as shown in FIG. 3 in which each pair of LEDs are reversely-oriented with each other. One driver IC 53 can drive-control more than two LEDs.

In the example shown in FIG. 6A, one backlight control IC (PWM) 54 performs driving control on four driver ICs 53-1-53-4. In the example of FIG. 6B, one backlight control IC (PWM) 54 performs driving control on one driver IC 53. In the example shown in FIG. 6C, one backlight control IC (PWM) 54 performs driving control on driver IC groups 55-1 and 55-2 in which a plurality of driver ICs 53 are connected serially.

In the above-mentioned configurations, in each of the backlight apparatus, the backlight control IC (PWM) 54 generates a control signal by performing pulse width modulation, and outputs a brightness control signal to the driver IC 53 or the driver IC group 55 in order to turn on LEDs in the element block at predetermined timing. Accordingly, the driver IC 53 or the driver IC group 55 can turn on corresponding LEDs at the predetermined timing.

As shown in FIGS. 6A-6C, the driver IC 53 or the driver IC group 55 controls output of a plurality of brightness blocks. Also, the backlight control IC (PWM) 54 shown in FIG. 6A supplies a voltage of 5-24 V at the maximum as a low voltage to the driver ICs 53-1-53-4 of low withstand voltage. The backlight control IC (PWM) 54 shown in FIG. 6B supplies a high voltage determined according to the number of serially-connected LEDs to the driver IC 53 of high withstand voltage. The high voltage may be set to be a voltage that is increased in proportion to the number of serially-connected LEDs. For example, assuming that a Vf voltage of one LED is about 3 V, the voltage becomes about 150 V when 50 LEDs are serially connected, and the voltage becomes about 300 V when 100 LEDs are serially connected.

Accordingly, as to the case of FIG. 6A, LED currents i1, i2, i3 and i4 flow through the driver ICs 53-1-53-4 respectively, so that the brightness is determined based on the current value. On the other hand, according to the driver 5C 13 of high withstand voltage of the present embodiment shown in FIG. 6B, since one LED current i flows, the brightness is proportional to the current, and the brightness becomes constant. Therefore, according to the present embodiment, the current supply line is integrated by the high-withstand voltage driver IC, so that the current can be always supplied stably and unevenness of brightness of LEDs can be prevented. Also, as shown in FIG. 6C, even in the case where LEDs are placed in the whole backside of the screen of the display unit 51, the number of driver ICs can be decreased by using high-withstand voltage driver ICs as the driver IC groups 55-1 and 55-2, so that wiring structure and the like can be simplified.

<Placement Example of LED Backlights>

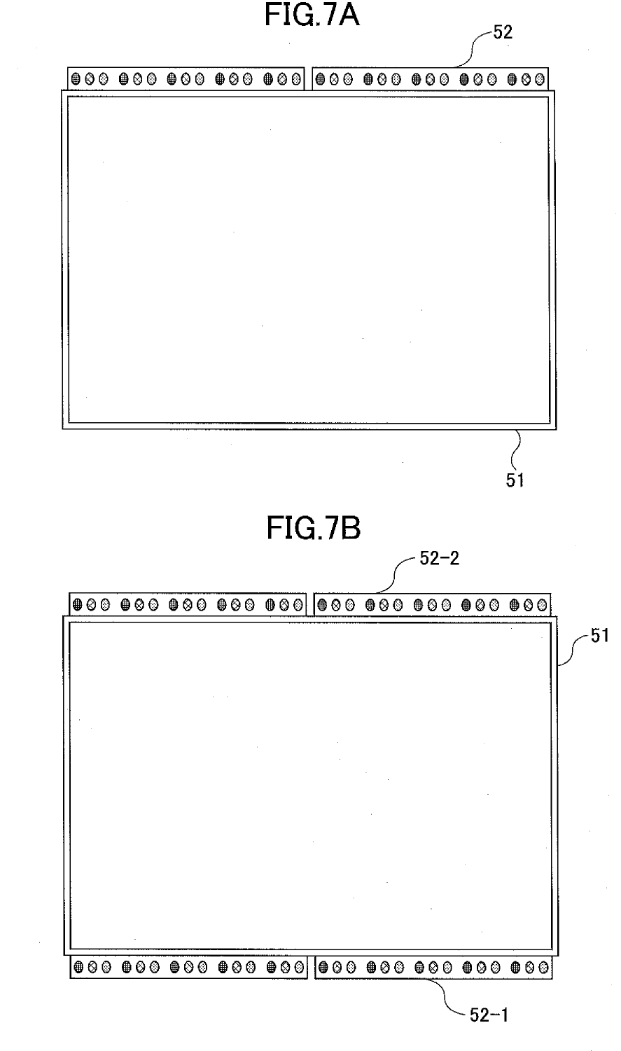

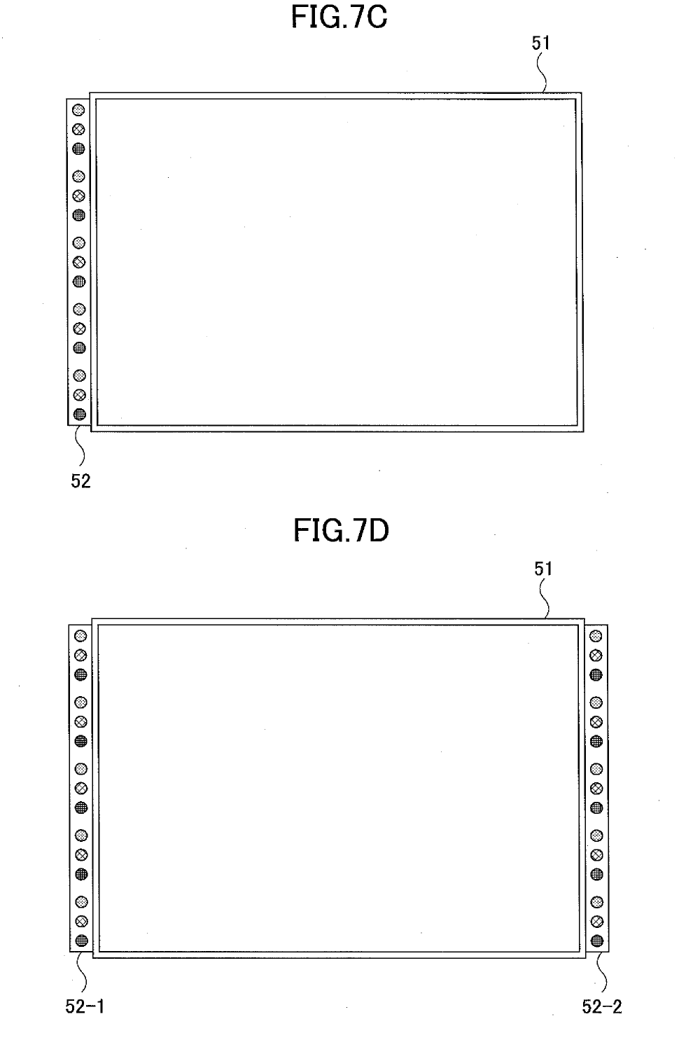

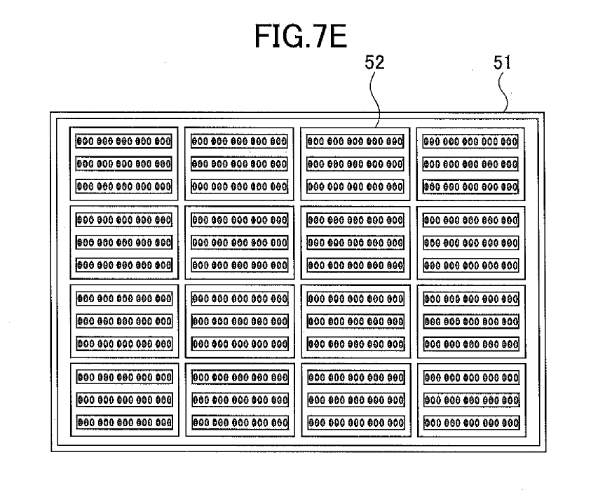

Next, examples of arrangement of the LED backlights are described with reference to drawings. FIGS. 7A-7E are diagrams for explaining arrangement examples of LED backlights.

As shown in FIGS. 7A-7E, the display unit 51 such as an LCD (Liquid Crystal Display) panel is provided with element blocks 52 at predetermined positions, wherein a plurality of LEDs are arranged at predetermined positions in each element block 52.

More specifically, in the example shown in FIG. 7A, an element block 52 is placed on the upper side of the display unit 51. In the example shown in FIG. 78, element blocks 52-1 and 52-2 are placed on upper and lower sides of the display unit 51. In addition, as shown in the example of FIG. 7C, the element block 12 may be placed on one side (left or right, left in the case of FIG. 7C) of the display unit 51. Also, as shown in FIG. 7D, the element blocks 52-1 and 52-2 may be placed in both of the left and the right sides. Further, as shown in FIG. 7E, a predetermined number of element blocks 52 may be arranged on the backside of the display unit 51.

In the present invention, backlight placement is not limited to the above-mentioned examples. For example, the element blocks may be placed in upper and lower sides in addition to the left and right sides, and two or more of the above-mentioned examples may be combined. Also, the element block 12 may be divided into blocks of a size according to at least one of detection results of APL (Average Picture Level) detection, brightness histogram detection, color histogram detection and frequency histogram detection obtained from an input image signal, for example. The present invention is not limited to this, and the element block 12 may be divided in units of predetermined blocks.

In the present embodiment, when a fault such as non-lighting occurs due to an end of life and the like in at least one of LEDs that are serially connected in the element block 12, bypass driving control may be performed such that the faulted LED does not affect the other LEDs.

<Block Information>

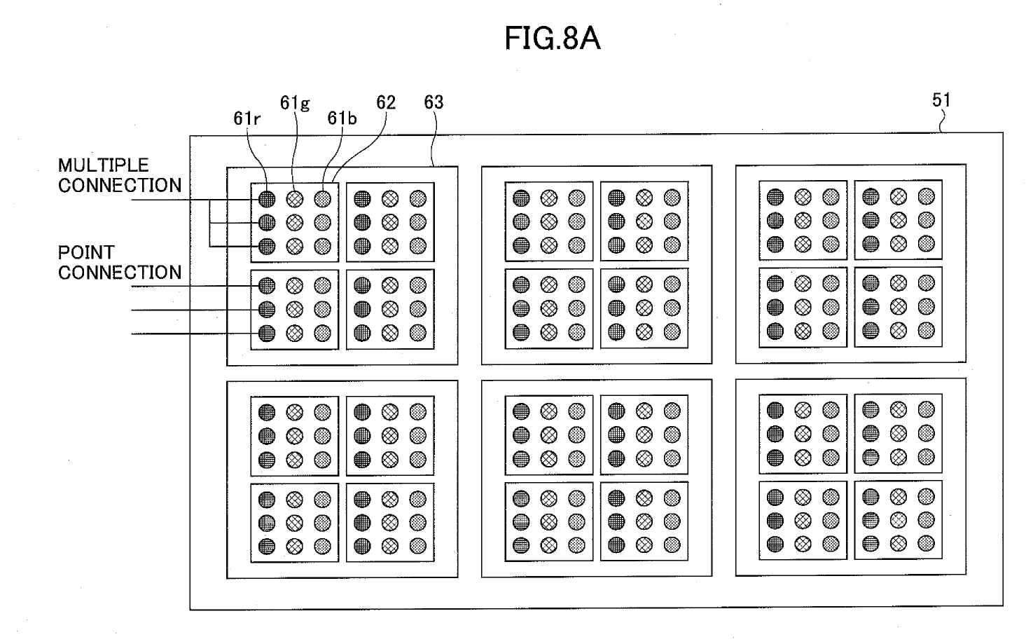

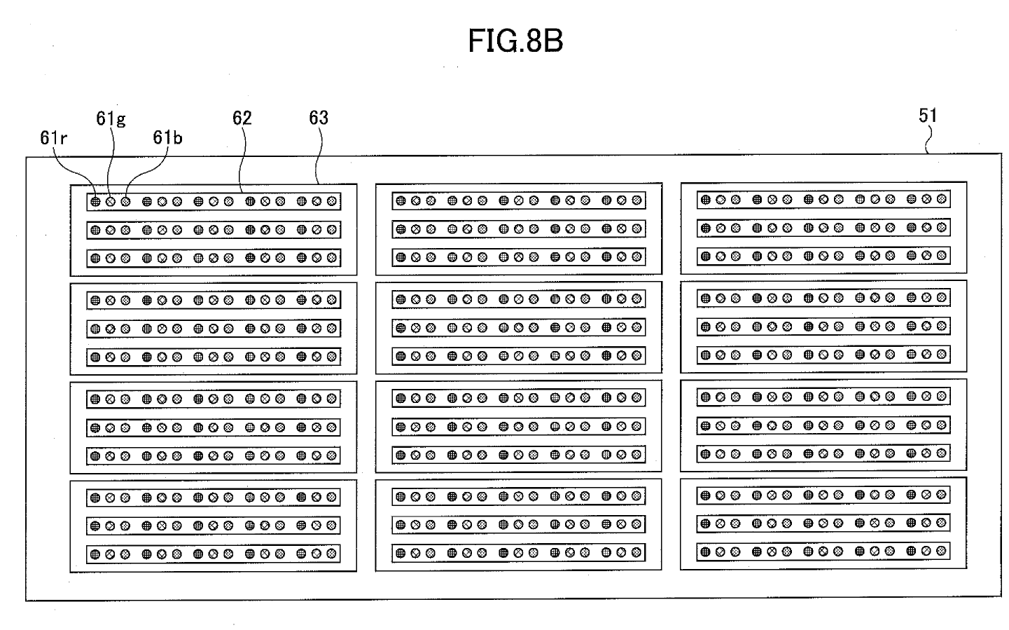

Next, examples of block configurations of the light-emitting elements (LEDs) are described with reference to figures. FIGS. 8A and 8B show examples of block configurations of light-emitting elements that can be applied in the present embodiment. Each of FIGS. 8A and 8B shows LEDs for an LCD backlight unit.

As shown in FIGS. 8A and 8B, a predetermined screen display area includes elements 61r, 61g and 61b for R, G and B respectively. These elements are connected to driver ICs by multiple connections or point connection.

Also, in the examples of FIGS. 8A and 8B, the elements 61r, 61g and 61b of the colors form a cell. In addition, in the examples of FIGS. 8A and 8B, a plurality of cells form an element block 62, and a predetermined number of element blocks 62 are placed at predetermined positions, which form a brightness control block 63 for performing control of brightness correction and the like. In the present embodiment, although examples of the number and the placement of the blocks are shown in FIGS. 8A and 8B, the present embodiment is not limited to those. These are properly set according to screen side of the display unit 51 and the like.

The backlight shown in FIGS. 8A and 8B is a so-called top-type backlight that is placed on the backside of the LCD panel. But, the present invention is not limited to that type. For example, a configuration of a so-called edge type can be used in which the backlight is placed in the lower side of the screen of the display unit 51, or placed in one side (right side, left side) or both sides of the screen.

<Block Configuration of the Backlight Control IC (PWM) 54>

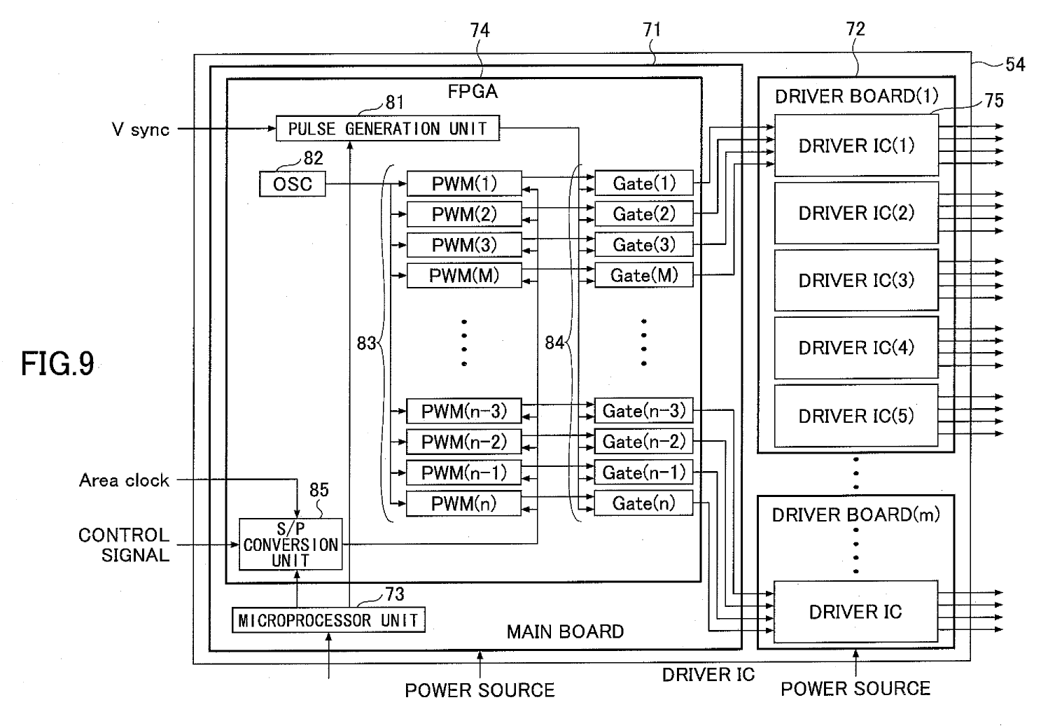

Next, a concrete block configuration example of the backlight driving control IC (PWM) 54 is described. FIG. 9 is a diagram showing an example of a block configuration of the backlight control IC (PWM) 54 in the present embodiment.

The backlight control IC (PWM) 54 shown in FIG. 9 includes a main board 71 and a driver board 72. The main board 71 includes a microprocessor unit 73 and a FPGA (Field Programmable Gate Array) 74. The driver board 72 includes a plurality of driver ICs 75. Also, the FPGA 74 includes a pulse generation unit 81, an OSC (Oscillator) 82, a PWM array 83, a gate array 84, and a S/P (serial/parallel) conversion unit 85. Further, power is supplied from a power supply to the main board 71 and the driver board 72 shown in FIG. 9.

Based on control information obtained from the microprocessor unit 73, the main board 71 outputs a control signal for driving backlights of each block provided in the backlight apparatus 50 to one or more driver ICs corresponding to the control information in one or more driver ICs provided on one or more driver boards 72 by using the gate array 84 formed in the FPGA 74.

More particularly, in the main board 71, the pulse generation unit 81 in the FPGA 74 generates a pulse signal for performing brightness control of backlights in synchronization with the timing of the image signal based on a synchronization signal (Vsync) obtained from the timing control unit. Then, the pulse generation unit 81 outputs the generated pulse signal to each gate array 84.

The OSC 82 generates a reference signal that becomes a reference of a PWM signal generated by each PWM circuit of the PWM array 83, and outputs the reference signal to each PWM circuit of the PWM array 83.

Also, in the main board 71, the S/P conversion unit 85 provided in the FPGA 74 converts the control signal in a serial form obtained from the outside into a signal of a parallel form based on an area clock of each block, and outputs the control signal to PWM circuit(s) corresponding to the area clock among the PWM circuits 1-n provided in the PWM array 83.

In the PWM array 83, each PWM circuit performs pulse width modulation based on the reference signal obtained by the OSC 82 and the control signal obtained by the S/P conversion unit 85, so as to generate a control signal for controlling ON/OFF of light emission of the light-emitting element such as the LED, for example. Then, the PWM circuit outputs the generated signal to a gate circuit corresponding to each PWM circuit provided in the gate array 84.

In the gate array 84, based on the pulse signal obtained from the pulse generation unit 81 and the control signal obtained from the PWM array 83, a control signal is output from gate circuit(s) to one or more driver ICs corresponding to the gate circuit(s) provided on the gate array 84 among one or more driver ICs provided on the driver boards 72

The microprocessor unit 73 outputs a control signal to the pulse generation unit 81 and the S/P conversion unit 85 based on externally set information or pre-recorded setting information and the like. Accordingly, the backlight control IC (PWM) 54 can cause each backlight provided in the backlight apparatus 50 to perform proper driving operation.

In the driver boards 72, one or more driver ICs (driver ICs 1-5 in the driver board (1) in the example of FIG. 9, for example) in each of driver boards (driver boards 1-m in the example of FIG. 9, for example) output a driving control signal for driving each backlight of the backlight apparatus 50 based on the signal obtained from the corresponding gate circuit. Accordingly, the driving control signal generated by each driver IC is output to the backlight apparatus 50 so that control of each backlight is performed.

In each of the PWM array 83 and the gate array 84, a plurality of elements are provided so that it can support the number of brightness blocks 63 that is variably set for each image. That is, in each of the PWM array 83 and the gate array 84, a number of elements for supporting the maximum number of blocks that can be divided in the display unit 51 can be provided. In the present embodiment, as a unit for dividing, each pixel (1×1 pixel), a square block such as 2×2 pixels, 4×4 pixels, and 16×16 pixels can be considered, for example. But, the present invention is not limited to these. Also, each PWM circuit and each gate circuit may control backlight elements corresponding to a plurality of divided blocks that are predetermined.

The backlight control IC (PWM) 54 performs the above-mentioned processing, so that corresponding backlight elements such as LEDs can be turned on or off at proper timing based on the driving control signal from the driver ICs 75. Further, by using the above-mentioned LEDs that are oppositely-connected with each other as backlights of the backlight apparatus 50, LEDs can be turned on at high speed, so that driving efficiency of the driver IC can be improved, and driving speed can be improved. Accordingly, reduction of cost can be realized.

<Image Display System using Backlight Apparatus>

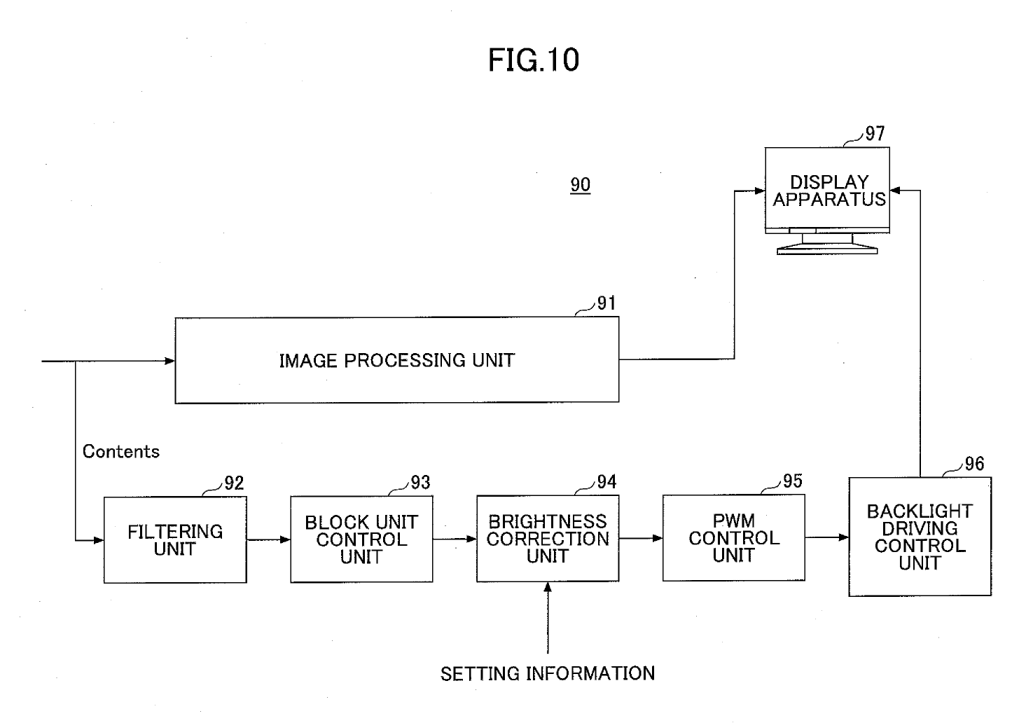

Next, an image display system using the above-mentioned backlight apparatus is described in detail. FIG. 10 shows an example of a functional configuration of an image display system using the backlight apparatus in the preset embodiment. The image display system 90 shown in FIG. 10 includes an image processing unit 91, a filtering unit 92, a block-unit control unit 93, a brightness correction unit 94, a PWM control unit 95, a backlight driving control unit 96 and a display unit 97. The backlight driving control unit 96 and the display unit 97 correspond to the above-mentioned backlight apparatus 50. Also, the backlight driving control unit 96 corresponds to the above-mentioned backlight control IC (PWM) 54.

In the image display system 90 shown in FIG. 10, an input image signal is output to the image processing unit 91 and to the filtering unit 92. The image processing unit 91 decodes an input image signal in a case when the image signal is compression-coded. Also, in a case when the image signal is encrypted by scrambling and the like in a conditional access system, the image processing unit 91 decodes (descrambles) the input image signal using preset key information. That is, the image processing unit 91 properly converts the input image signal to generate an image signal that can be displayed on the display unit 97. Also, the image processing unit 91 outputs the image signal to the display unit 97 at a proper timing.

The filtering unit 92 performs smoothing processing for the signal before performing processing in later stages. More particularly, the filtering unit 92 performs filtering processing on the signal using a low-pass filter according to a grade of the input image signal. In addition, the filtering unit 92 can decode an input image signal in a case when the image signal is compression-coded. Also, in a case when the image signal is encrypted by scrambling and the like in a conditional access system, the filtering unit 92 can decode (descramble) the input image signal using preset key information and the like.

The filtering unit 92 outputs the filtered image signal to the block-unit control unit 93. The block-unit control unit 93 sets a size (the number of pixels, inches and the like) of a block unit for the image signal based on preset control information for each image signal. Accordingly, by setting the size of the block unit, the backlight can be controlled for each block unit in association with image information.

That is, the block-unit control unit 93 divides the image signal into blocks for each frame based on established block information, and generates control information for performing brightness control for each divided block by offset control and non-linear correction and the like, for example. In addition, the block-unit control unit 93 generates control information for performing brightness control processing which includes at least one of APL detection, brightness histogram detection, color histogram detection and frequency histogram detection for each block. In the present embodiment, it is desirable to combine APL detection result with at least one of the histogram detection results in the brightness control processing.

Also, the block-unit control unit 93 can perform modulation processing by PWM and the like for the input image signal. The block-unit control unit 93 outputs control information generated for each block to the brightness correction unit 94.

The brightness correction unit 94 corrects brightness information of backlights for each block (in units of blocks) using externally set information or pre-recorded setting information based on the brightness control processing result for each block, and outputs the correction signal to the PWM control unit 95.

The PWM control unit 95 generates a backlight driving control signal based on the corrected brightness information, and outputs the generated backlight driving control signal to the backlight driving control unit 96. Therefore, the backlight driving control unit 96 can control the backlights of the whole screen provided in the display unit 97 for each block by the above-mentioned processing. In addition, by using the above-mentioned LEDs, as backlights that are oppositely-connected with each other of the present embodiment described before, LEDs can be turned on at high speed, so that driving efficiency of the driver IC can be improved, and driving speed can be improved. Accordingly, reduction of cost can be realized.

As mentioned above, in the present embodiment, brightness correction is performed for backlights. By adopting such configuration, as mentioned above, an optimal image that a user can easily watch can be displayed on the display screen, and power consumption can be reduced efficiently.

The configuration of the image display system using the backlight apparatus in the present embodiment is not limited to one described above. For example, backlights of the display unit can be dynamically operated in conjunction with image contents by feeding correction information of each block in the brightness correction unit 94 back to the image contents. Thus, images of higher contrast can be provided. That is, by adopting the above-mentioned configuration, optimal backlight control can be performed according to image contents.

<Other Application Examples of the Backlight Apparatus>

The backlight apparatus of the above-mentioned embodiment can be applied to a lighting apparatus, a digital signage, and other various displays and the like as well as the above-mentioned display apparatus such as a TV. That is, the backlight apparatus of the present embodiment can be applied to overall apparatuses that can drive LEDs oppositely-connected in each pair as mentioned above. In the following, other application examples of the backlight apparatus are described with reference to drawings.

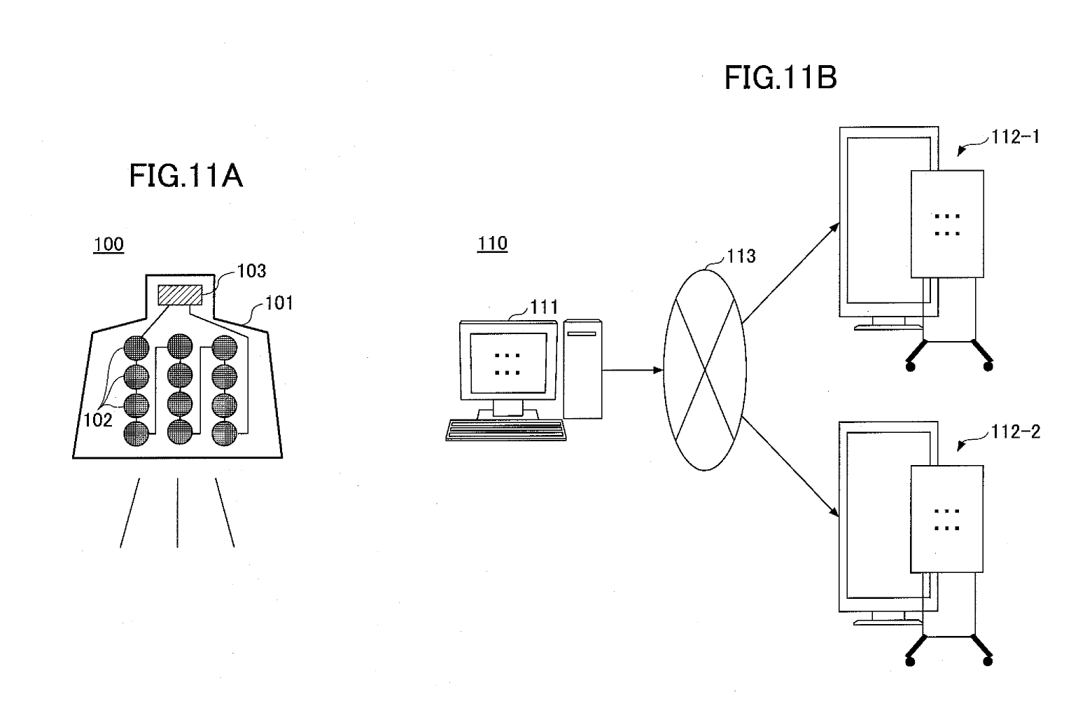

FIGS. 11A and 11B are diagrams for explaining other application examples of the backlight apparatus of the present embodiment. FIG. 11A shows an example in which the backlight apparatus of the present embodiment is applied to a lighting apparatus, and FIG. 11A shows an example in which the backlight apparatus of the present embodiment is applied to a digital signage system.

The lighting apparatus 100 shown in FIG. 11A is an LED lamp as an example. More specifically, the lighting apparatus 100 is configured such that a plurality of LEDs 102 are serially connected in a lamp body 101, and each LED is placed at a predetermined position suitable for a proper lighting direction. Each LED 102 shown in the figure indicates a pair of LEDs that are oppositely-connected with each other. Each LED 102 may be configured to be the above-mentioned light-emitting element block.

The LEDs 102 are connected to the above-mentioned driver IC (LED driving control unit) 103 as shown in FIG. 11A. Driving of each LED is controlled by the driver IC 103. By adopting such a configuration, lighting can be realized by light emitted from the plurality of LEDs. In addition, by using the above-mentioned LEDs that are oppositely-connected with each other, LEDs can be turned on at high speed, so that driving efficiency of the driver IC can be improved, and driving speed can be improved. Accordingly, reduction of cost can be realized.

In addition, in the present embodiment, a bypass circuit may be provided for each LED 102 shown in FIG. 11A. Therefore, according to the lighting apparatus 100, even when a break occurs in an LED, a current from the driver IC 103 can be supplied to the other LEDs.

The digital signage system 110 shown in FIG. 11B is configured, for example, to include a PC (personal computer) 111 and a plurality of digital signage apparatuses 112 (digital signage apparatuses 112-1 and 112-2 in the example of FIG. 11B). The PC 111 and the digital signage apparatuses 112 are connected via a communication network 113 represented by the Internet such that transmit and receive of data are available.

In the digital signage system 110 shown in FIG. 11B, contents such as product description and a company name that are created and edited using the PC 111 by a manager are displayed and updated simultaneously on the digital signage apparatuses 112 placed in different places via the communication network 113. Each digital signage apparatus 112 uses a large-sized liquid crystal display, for example, and the backlight apparatus can be applied to such a large-sized liquid crystal display. Also, in the configuration of FIG. 11B, the oppositely-connected LEDs of the present embodiment are used similarly to the configuration shown in FIG. 11A.

For example, also in the digital signage apparatuses 112 shown in FIG. 11B, as LEDs arranged for the backlight apparatus, by using the above-mentioned LEDs that are oppositely-connected with each other of the present embodiment, LEDs can be turned on at high speed, so that driving efficiency of the driver IC can be improved, and driving speed can be improved. Accordingly, reduction of cost can be realized.

In addition, also in the configuration shown in FIG. 11B, by providing the above-mentioned bypass circuit for each LED, according to the digital signage apparatus 112, a current from the driver IC can be supplied to the other LEDs even when a break occurs in an LED. Further, the backlight apparatus can be also applied to a liquid crystal display of the PC 111 shown in FIG. 11B.

As mentioned above, according to the embodiment of the present invention, reduction of cost can be realized, and improvement of driving efficiency and driving speed can be realized. The backlight apparatus of the present embodiment can be widely applied to backlight mechanisms for various display apparatuses such as a display screen of a liquid crystal TV, a display of a personal computer, a display screen of a portable terminal, a display screen of a digital camera and the like.

The present invention is not limited to the specifically disclosed embodiments, and variations and modifications may be made without departing from the scope of the present invention.

What is claimed is:

1. A backlight apparatus for illuminating a display unit, comprising:
light-emitting elements that are arranged at predetermined intervals; and
a driving control unit configured to supply currents to the light-emitting elements so as to control driving of the light-emitting elements,
wherein the light-emitting elements include a pair of a first light emitting-element and a second light-emitting element that are connected to the driving control unit and that are connected in parallel to each other, in which the first light-emitting element is connected in a direction opposite to a direction in which the second light-emitting element is connected.

2. The backlight apparatus as claimed in claim 1, the driving control unit comprising a differential circuit configured to control the currents supplied to the light-emitting elements.

3. The backlight apparatus as claimed in claim 1, further comprising a current resistance unit configured to adjust supplied currents for each of the light-emitting elements.

4. The backlight apparatus as claimed in claim 1, further comprising a backlight driving control unit configured to generate a driving condition for the driving control unit and to output a driving control signal to the driving control unit.

5. An image display system comprising:
a backlight apparatus;
a display unit to be illuminated by the backlight apparatus,
the backlight apparatus comprising:
light-emitting elements that are arranged at predetermined intervals; and
a driving control unit configured to supply currents to the light-emitting elements so as to control driving of the light-emitting elements,
wherein the light-emitting elements include a pair of a first light emitting-element and a second light-emitting element that are connected to the driving control unit and that are connected in parallel to each other, in which the first light-emitting element is connected in a direction opposite to a direction in which the second light-emitting element is connected.

6. The image display system as claimed in claim 5, further comprising:
a block-unit control unit configured to divide each frame, included in an input image signal, into blocks corresponding to block information that is set beforehand; and
a brightness correction unit configured to perform brightness correction for each of the blocks obtained by the block-unit control unit,
wherein the backlight apparatus performs drive control on plural light-emitting elements assigned for each block based on correction information obtained by the brightness correction unit.

7. A lighting apparatus comprising:
light-emitting elements that are arranged at predetermined intervals; and
a driving control unit configured to supply currents to the light-emitting elements so as to control driving of the light-emitting elements,
wherein the light-emitting elements include a pair of a first light emitting-element and a second light-emitting element that are connected to the driving control unit and that are connected in parallel to each other, in which the first light-emitting element is connected in a direction opposite to a direction in which the second light-emitting element is connected.
